(19) United States
(12) Patent Application Publication
(10) Pub. No.: US 2015/0107680 A1
(43) Pub. Date: Apr. 23, 2015

(54) MODULATING CHECK VALVE

(71) Applicants: Walter R. Chapman, JR., Cleveland Heights, OH (US); James W. Swoger, Albion, PA (US)

(72) Inventors: Walter R. Chapman, JR., Cleveland Heights, OH (US); James W. Swoger, Albion, PA (US)

(21) Appl. No.: 14/061,376

(22) Filed: Oct. 23, 2013

(51) Int. Cl. F04C 28/24; F04C 18/08; F16K 1/20; G05D 16/16; F16K 15/18

(52) U.S. Cl. CPC F04C 28/24; G05D 16/16; F16K 15/186; F16K 1/2007; F04C 18/08
USPC 137/12; 137/492.5

(57) ABSTRACT

A modulating check valve and method of operating the modulating check valve adapted for mounting to an inlet of a compressor. The modulating check valve includes a flow section through which fluid flow. The flow section has an intake portal and an outlet portal connected to the inlet of the compressor. A flapper valve is disposed in the flow section to prevent backflow from the outlet portal to the intake portal. An actuator controls the flapper valve allowing the flapper valve to open, close and modulate the fluid flow from the intake portal to the outlet portal of the flow section in response to fluid pressure at an outlet of the compressor.

### FIELD OF THE INVENTION

The present invention relates generally to rotary screw type compressor systems and to check valves, and, more specifically, the present invention relates to a disk- or flapper-type check valve that can be mechanically modulated to a fully open, fully closed or a partially closed position during fluid flow.

### BACKGROUND OF THE INVENTION

Compressors are used in a wide variety of industrial and residential applications. Compressors are also used to inflate or otherwise impart a fluid force on an external object such as tires or pneumatic tools. It is always desirable that a compressor provide consistent and efficient operation to ensure that the particular application (e.g., pneumatic tools) functions properly. To that end, modulation of compressor inlet conditions, e.g., of flow rate and pressure, and to prevent back flow, can provide reliable and efficient compressor and system operation. Intake modulation is also desired at start-up of the compressor to reduce the usual start-up strain and power requirement on the compressor motor.

Rotary-screw air compressors are equipped with the usual oil feed system which responds to pressure developing in the air receiver after start-up to feed lubricating cooling oil to the moving components of the compressor so a check valve to prevent back flow is required.

### SUMMARY OF THE INVENTION

According to the present invention, a modulating check valve adapted for mounting to an inlet of a compressor including a flow section through which fluid flow. The flow section has an intake portal and an outlet portal connected to the inlet of the compressor. A flapper valve is disposed in the flow section to prevent backflow from the outlet portal to the intake portal. An actuator controls the flapper valve allowing the flapper valve to open, close and modulate the fluid flow from the intake portal to the outlet portal of the flow section in response to fluid pressure at an outlet of the compressor.

Further according to the present invention, a method for modulating the fluid flow to a compressor includes directing fluid flow through a flow section of a modulating check valve having an intake portal and an outlet portal connected to the inlet of the compressor. The method includes preventing backflow from the outlet portal to the intake portal and in response to fluid pressure at an outlet of the compressor, the fluid flow is modulated from the intake portal to the outlet portal of the flow section.

### BRIEF DESCRIPTION OF THE DRAWINGS

The structure, operation, and advantages of the present invention will become further apparent upon consideration of the following description taken in conjunction with the accompanying figures (Figures). The figures are intended to be illustrative, not limiting.

Certain elements in some of the figures may be omitted, or illustrated not-to-scale, for illustrative clarity. The cross-sectional views may be in the form of slices, or near-sighted cross-sectional views, omitting certain background lines which would otherwise be visible in a true cross-sectional view, for illustrative clarity.

Often, similar elements may be referred to by similar numbers in various figures (Figures) of the drawing, in which case typically the last two significant digits may be the same, the most significant digit being the number of the drawing figure (Figure).

FIG. 1 is an orthogonal top view of a modulating check valve, according to the present invention.

FIG. 2 is an orthogonal cross sectional side view of the modulating check valve, according to the present invention.

FIG. 3 is schematic line diagram of the location of the modulating check valve in relation to other systems it is intended for use in conjunction with.

FIG. 4 is an orthogonal cross sectional side view of the flapper valve of the modulating flapper valve in an open position, according to the present invention.

FIG. 5A is an orthogonal hinge axis view of the closure device (flapper) of the modulating check valve, according to the present invention.

FIG. 5B is an orthogonal exhaust view of the flapper valve of the modulating check valve, according to the present invention.

FIG. 5C is an orthogonal hinge end-on view of the flapper valve of the modulating check valve, according to the present invention.

FIG. 5D is an orthogonal inlet view of the flapper valve of the modulating check valve, according to the present invention.

FIG. 5E is a sectioned detail view of the O-ring seal in the flapper valve of the modulating check valve, according to the present invention.

FIG. 5F is a perspective exhaust view of the flapper valve of the modulating check valve, according to the present invention.

FIG. 5G is a perspective inlet view of the flapper valve of the modulating check valve according to the present invention.

FIG. 6A is an orthogonal cross sectional view of the piston portion of the modulating check valve, according to the present invention.

FIG. 6B is a perspective view of the piston portion of the modulating check valve, according to the present invention.

FIG. 6C is an orthogonal, cross-sectional view of the piston and stem portions of the modulating check valve, according to the present invention.

FIG. 6D is a perspective view of the piston and stem portions of the modulating check valve, according to the present invention.

### DETAILED DESCRIPTION OF THE PREFERRED EMBODIMENT

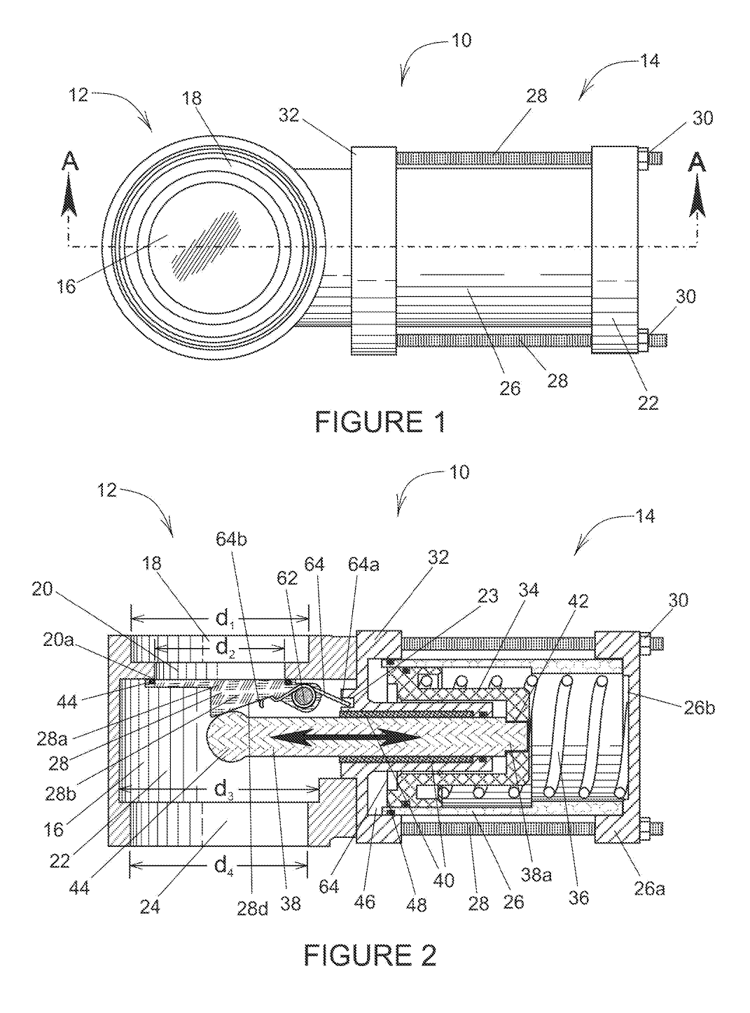

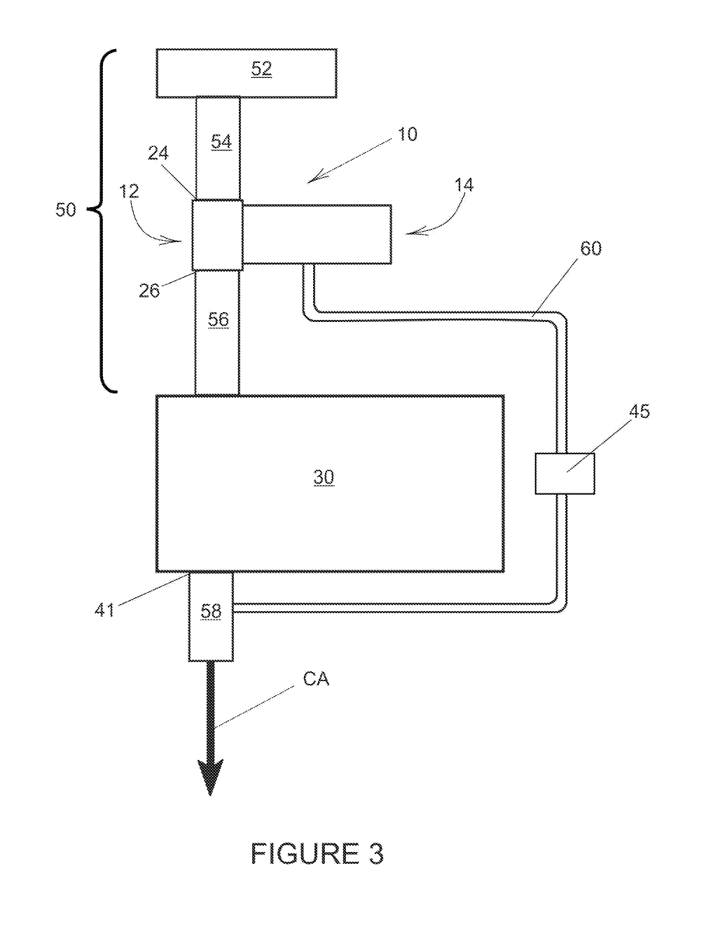

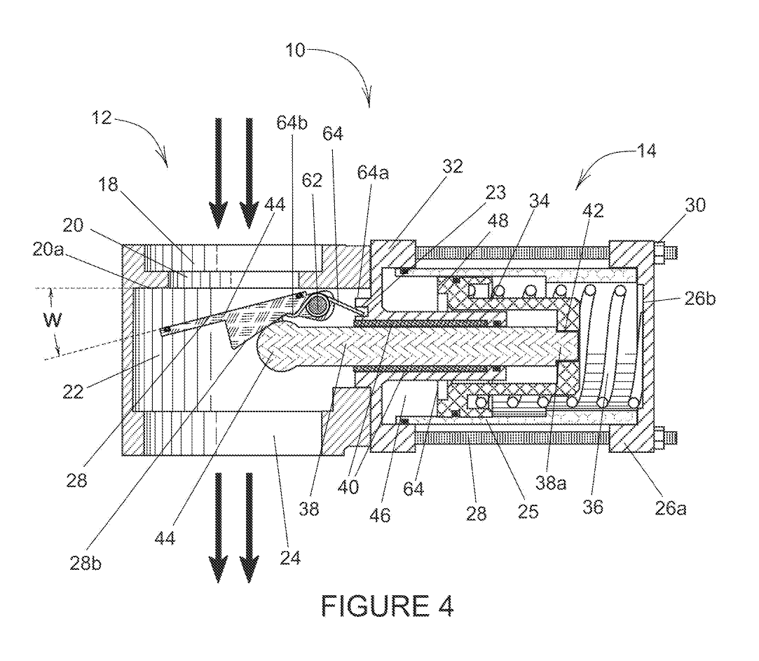

The present embodiment relates to a modulating check valve 10 designed for use with a rotary-screw type gas compressor 30, as shown in FIG. 3. The modulating check valve 10 is shown in top view in FIG. 1. The modulating check valve 10 consists of a flow section 12, through which a fluid, such as gas, flows into a rotary-screw type gas compressor 30, and an actuator section 14, which contains a pneumatic cylinder and piston, as shown in FIGS. 2 and 4, that modulates the gas flow through the flow section 12, in ways described below. While rotary-screw type gas compressor 30 can compress many types of fluids including gasses, it is typically used to compress air, and called an air compressor herein.

As shown in FIG. 2, the flow section 12 of the modulating check valve 10 incorporates a conduit 16 through the flow section 12. The conduit 16 has an intake portal 18 having a first diameter d1 at one end and a valve seat section 20 downstream and adjacent to intake portal 18 having a second diameter d2. The conduit 16 further includes an intermediate section 22 disposed downstream and adjacent the valve seat section 20 and having a third diameter d3 being greater than the second diameter d2. Continuing, the conduit 16 further includes an outflow portal 24 downstream and adjacent the intermediate section 22 and having a fourth diameter d4 being less than the third diameter d3. Further, as shown in FIG. 2, the flow section 12 of the modulating check valve 10 has a side opening 26 communicating with the intermediate section 22 and adapted to receive actuator section 14.

The modulating check valve 10, according to the present invention, is self-modulating in a way that becomes evident upon contemplation of the orthogonal, cross-sectional, side view of the modulating check valve 10 in FIGS. 2 and 4, through the section A-A indicated in FIG. 1. In FIG. 2, a valve closure device, typically a disk-type flapper valve 28 is shown in a closed position against the valve seat 20a on the downstream side of valve seat section 20. In this condition, no air would flow though the conduit 16. Alternatively, if the flapper valve 28 were open as shown in FIG. 4, the air, see arrows, would flow through the intake portal 18 of conduit 16, across the valve seat section 20, through intermediate section 22, out of outflow portal 24 and to a rotary-screw compressor 30.

Referring again to FIGS. 2 and 4, there is illustrated a cross sectional view of the actuator section 14 of the modulating check valve 10. As shown in FIG. 1, the actuator section 14 consists of a cylinder 26 having an end plate 26a secured thereto and to a flange 32 that is mounted to the side opening 26 of the flow section 12 by threaded rods 29 and nuts 31.

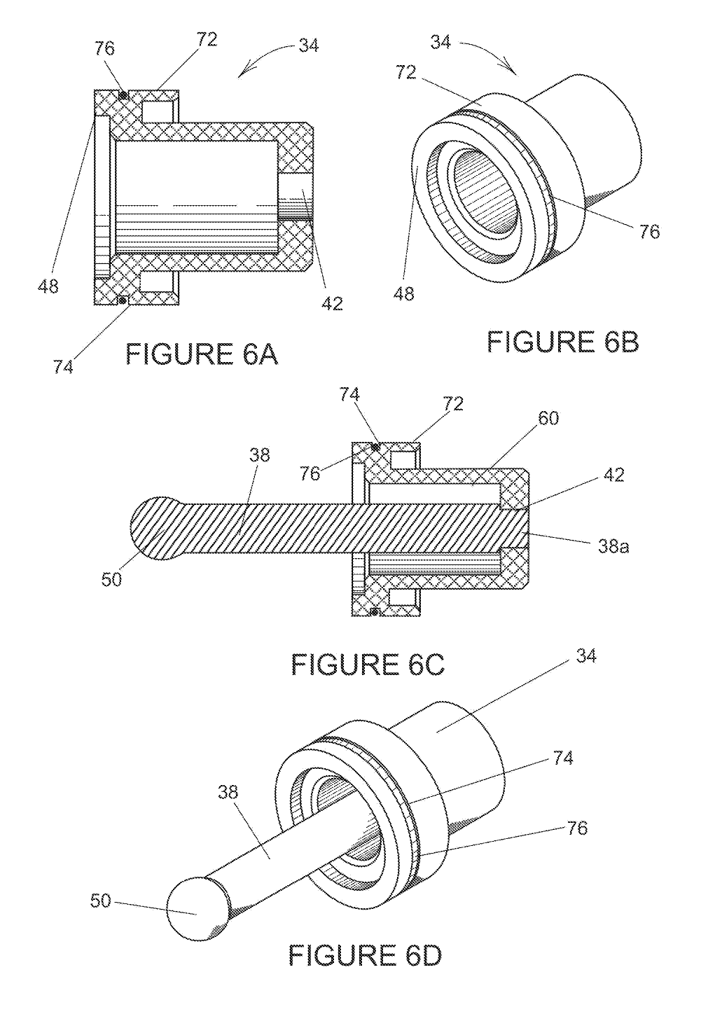

Returning now to the orthogonal cross sectional view of FIG. 2, the cylinder 26 of the actuator section 14 houses a piston 34 that is slidably received within the cylinder. The piston 34, as shown in detail in FIGS. 6A-6D, is biased towards flange 32 by a compression spring 36 that engages the interior surface 26b of the end plate 26a.

A stem 38 is slidably mounted (as indicated by the two-headed arrow) within bushing 40 which is fixed within the flange 32. One end of the stem 38 has a reduced diameter portion 38a that is secured within a receptacle 42 of piston 34. The opposite end of stem 38 has a spherical end knob 44. While a spherical end knob 44 is illustrated, it is within the terms of the preferred embodiment to employ another end, such as a roller ball. The spherical end knob 44 engages the disk-type flapper valve 28. As discussed in more detail below, high air pressure in variable cylinder volume 46 at one end of cylinder 26 acts against piston 34 so as to push it to the right against the bias of compression spring 36 and thereby force the spherical end knob 44 of stem 38 to the right so that the flapper valve 28 will open by air flow through conduit 16. The high-pressure air is provided by a control valve 45 in line 60 when the pressure from the output side of the compressor 30 is below a certain predetermined value. The high-pressure air from control valve 45 enters the cylinder volume 46 within cylinder 26 and acts against surface 48 of the piston 34, so as to push the piston and stem 38 to the right. Compression spring 36 acts against piston 34 so as to push it to the left against the action of high-pressure air in cylinder volume 46 opposing the motion of the piston to the right. As should be evident to those skilled in the art, when air pressure within the cylinder volume 46 is sufficiently high to overcome the force of compression spring 36, the piston 34, along with stem 38, moves to the right as shown in FIG. 4 such that the spherical end knob 44 of stem 38 will move away from ramp portion 28b of the flapper valve 28, thereby allowing the flapper valve to open.

Before continuing the discussion of the components and the operation of the modulating check valve 10, it would be useful to understand how the check valve is disposed in relation to a rotary screw compressor 30, as shown in FIG. 3. The modulating check valve 10 is disposed within the air induction or intake side 50 of the compressor 30. More specifically the modulating check valve 10, shown within flow section 12, is disposed between an air filter 52 and the rotary screw compressor 30. A conduit 54 communicates air from the air filter 52 to the modulating check valve 10, and another conduit 56 communicates air from the modulating check valve to the compressor 30. Compressed air, indicated by black arrow CA, exits the compressor 30 by way of conduit 58 which communicates with machinery or storage tanks (not shown) which receive compressed air from the compressor. A tube or conduit 60 conveys a pressure signal from conduit 58, or, more generally, from the output side of the compressor 30, to the control valve 45 which directs pressurized air to the cylinder volume 46 in actuator section 14 of the modulating check valve 10.

The detailed operation of the modulating check valve invention 10 can now be described with reference to the cross-sectional view of the modulating check valve 10 as illustrated in FIGS. 2 and 4. The disk-type flapper valve 28 is hinged about a hinge pin 62. A closing device, such as a torsional spring 64, using the hinge pin 62 as a fulcrum, is anchored at one end 64a in a recess 23 in the flange 32, with its other end 64b exerting a closing force against the flapper valve 28. The torsional spring 64 provides a weak closing force against a ramp portion 28b of the disk-type flapper valve 28 such that the flapper valve tends toward a closed position when the air flow rate through the flow section 12 is minimal, regardless of the orientation of the modulating check valve 10.

Referring to FIG. 4, the flapper valve 28 illustrated in an open position, shows an angle w that defines the degree of openness. When the flapper valve 28 is closed, as shown in FIG. 2, the flapper valve angle w is 0 degrees. At maximum opening, the flapper valve angle w is about 85 degrees. Under that condition, air pressure in the cylinder volume 46 is sufficient that the assembly of the piston 34 and stem 38 are pushed to the extreme of their rightward motion within the cylinder 26, and the spring 36 is at its most compressed condition. Under conditions of normal operation for the compressor 30, the flapper valve 28 opens according to the pressure at the outlet side of the compressor, between a minimum of about 0 degrees and the maximum of about 85 degrees.

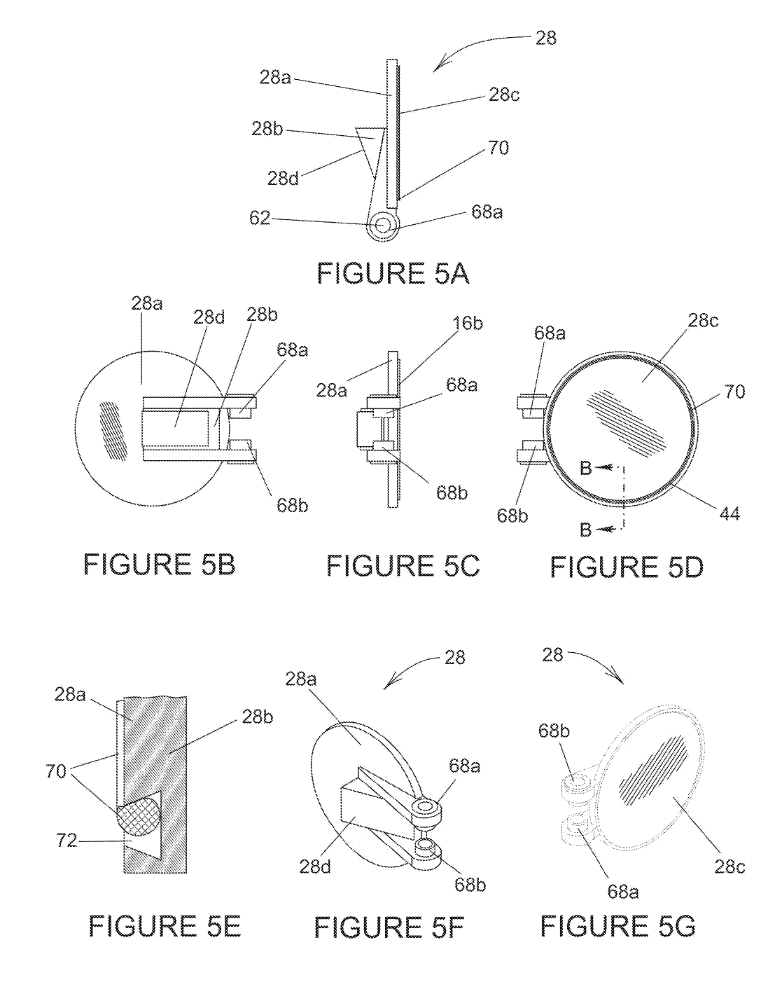

Referring to FIGS. 5A-5G, the flapper type, check valve 28 is shown in detail. FIG. 5A shows the pivot pin view of the flapper valve 28. The flapper valve 28 consists of a disk portion 28a, a ramp portion 28b, the inlet portal valve seating surface 28c of the disk (flapper) portion 28a, the ramp surface 28d and two hinge pin bosses 68a, 68b. FIG. 5B shows the flapper type check valve 28 in the view from the outlet portal 24; FIG. 5C shows the flapper type check valve in view from actuator 14; and FIG. 5D shows the flapper type check valve in the view from the intake portal 18, wherein the valve seating surface 28c of the flapper valve disk which seats against valve seat 20a has an O-ring 70 held within a circumferential groove 72. The disposition of the O-ring 70 within the circumferential groove 72 is revealed more specifically in FIG. 5E, which is section view B-B indicated in FIG. 5D. FIG. 5F and FIG. 5G are, respectively, perspective views of flapper valve 28 from the outlet portal 24 and intake portal 18, respectively.

Returning now to the orthogonal cross sectional view of FIG. 2, note that the ramp portion 28b of the flapper valve 28 is in contact with spherical end knob 44 of stem 38 which is slidably mounted (as indicated by the two-headed arrow) within bushing 40 which is fixed within the flange 32. Stem 38, at the end opposite the spherical end knob 44, has a reduced diameter portion 38a which engages with a receptacle 42 of piston 34. While a spherical end knob 44 is illustrated, it is within the terms of the preferred embodiment to employ another end, such as a roller ball. Piston 34 slides within the cylinder 26. The piston 34 is actuated by, and forced to the right by (as shown in FIG. 4), a low-pressure air signal from the output side 41 (FIG. 3) of the compressor 30 causing the control 45 to direct high-pressure air into the cylinder volume 46 within cylinder 26. The high-pressure air in the cylinder volume 46 acts against piston surface 48 of the piston 34, so as to push the piston and stem 38 to the right. Compression spring 36 acts against piston 34 so as to push it to the left against the action of high-pressure air in cylinder volume 46 opposing the motion of the piston to the right. As should be evident to those skilled in the art, when air pressure within the cylinder volume 46 is sufficiently high to overcome the force of compression spring 36, the piston 34, along with stem 38, moves to the right in FIG. 2 such that the spherical end knob 44 of stem 38 will move away from ramp portion 28b of the flapper valve 28, thereby allowing the flapper valve to open up, as shown in FIG. 4. FIG. 6A through FIG. 6D shows detailed views of the piston 34 individually and the piston and stem 38 assembled together. FIG. 6A shows the piston 34 in orthogonal cross sectional view including the piston surface 48 against which compressed air acts to make the piston move, and the receptacle 42 which receives the opposite end 38a of the stem 38. Around the larger circumference 72 of the piston 34 there is a groove 74 within which is held an O-ring seal 76. FIG. 6B is a perspective view of piston 34 showing the piston surface 48, larger circumference 72, and O-ring 76. FIG. 6C is an orthogonal side of the piston 34 with the stem 38 inserted in place within receptacle 42 as indicated in FIGS. 2 and 4.

### Operation of the Modulating Check Valve

FIG. 2 shows the modulating check valve 10 with the flapper valve 28 in a closed position, blocking the flow of air through the conduit 16 of the modulating check valve 10.

FIG. 4 shows the modulating check valve 10 with the flapper valve 28 in an open position having an angle w that defines the degree of openness. When the flapper valve 28 is closed, of course, the angle w is 0. At maximum opening, the angle w is about 85 degrees. Under the latter condition, air pressure in the cylinder volume 46 is sufficient that the assembly of the piston 34 and stem 38 are pushed to the extreme of their rightward motion within the cylinder 26, and the spring 36 is at its most compressed condition.

Under conditions of normal operation, when the airflow rate into the compressor 30 is high, the flapper valve 28 opens a maximum of about 85 degrees, according to pressure at the outlet of the compressor.

When the compressor 30 is not operating, the flapper valve 28 is in a fully closed position, as shown in FIG. 2, because of the low pressure in volume 46 allows spring 36 to move the piston 34 to the right. When the compressor 30 is started, the flapper valve 28 remains essentially closed and only a small amount of leakage air flows into the compressor. When the pressure in the conduit 58 on the output side of the compressor 30 rises to a predetermined level, a pressure signal is delivered to the control 45 by way of conduit 60, as seen in FIG. 3, which in turn directs high pressure air to the cylinder volume 46 of the actuator section 46 of the modulating check valve 10. The increased air pressure within the cylinder volume 46 forces piston 34 and stem 38 to the right, thereby allowing the flapper valve 28 to open up in response to the air being drawn through intake side 50 of the compressor 30 so that air freely flows to the inlet of compressor 30. The idea here is to allow a small amount of air into the compressor through a bleed valve or small hole (not shown), through compressor 30 until it has got up to speed, thereby reducing the startup load on the compressor motor that drives the compressor and allowing time for the compressor and its motor to get up to operating speed. Once the pressure on the output side of the compressor has reached a predetermined level, a pressure signal is sent to the controller 45 to allow the flapper valve 28 to fully open as discussed hereinbefore. During the normal operation of the compressor 30, the pressure in the conduit 58 on the output side of the compressor 30 varies depending on the requirements of compressed air usage by machinery or storage tanks (not shown) which receive compressed air from the compressor. As the flow rate requirement for the air decreases, as the demand for compressed air compressed goes down, the pressure in the conduit 58 on the output side of the compressor 30 rises so that an increasing high pressure signal delivered by way of conduit 60 to the controller 45, which in turn directs a decreasing low air pressure to the cylinder volume 46 of the modulating check valve 10. As the pressure in the cylinder volume 46 decreases, the piston 34 and stem 38 move to the left causing the flapper valve 28 to close as the need for air decreased.

Alternatively, as the demand for compressed air compressed goes back up because of the increased demand for compressed air by the machinery or storage tanks, the pressure in the conduit 58 on the output side of the compressor 30 drops so that a lower pressure signal is delivered by way of conduit 60 to the controller 45. The controller 45 in turn directs a higher air pressure to the cylinder volume 46 of the modulating check valve 10. The higher pressure in the cylinder volume 46 causes the piston 34 and stem 38 to move to the right allowing the flapper valve 28 to open more and more as the need for air increases.

As described above, the flapper valve 28 moves from an initially closed position when the compressor is off or idling, to a fully open position when the pressure at the outlet of the compressor reaches a predetermined minimum and then the valve begins to be closed by the stem 38 as the pressure at the outlet of the compressor increases. The effect is that the flapper valve 28 modulates the amount of air being delivered to the input of the compressor depending on the requirements of compressed air usage by machinery or storage tanks which receive compressed air from the compressor.

In the event that there is an emergency shutoff of the compressor 30, air flow from the air filter 52 and through the flow section 12 to the inlet of compressor 30 is minimal. In that case, the torsion spring 64, which provides a weak closing force against a ramp portion 28b of the disk-type flapper valve 28, biases the flapper valve toward a closed position, regardless of the orientation of the modulating check valve 10. Being that when the rotary-screw compressor suddenly closes down, compressed air and lubricant in the compressor will flow momentarily backwards into the modulating check valve 10. Since the flapper valve is closed or already nearly closed against the valve seat 20a, the back flow of the compressed air and lubricant from the compressor will cause the flapper valve 28 to slam shut and thereby block the back flow of compressed air as well as the lubricant through the modulating check valve device 10 and into the air cleaner 52.

Although the modulating check valve 10 is described with an actuator section 14 which contains a pneumatic cylinder and piston that moves a stem 38 to close the flapper valve 28 when the compressor has shut down, allowing the flapper valve 28 to be fully open once outlet pressure of the compressor reaches a predetermined minimum or the modulates the flapper valve as the outlet pressure of the compressor increases and decreases, it is within the terms of another embodiment to move the stem with an electric motor such as a stepper motor.

Also, while a single flapper valve is illustrated, it is within the terms of the preferred embodiment to provide two or more flapper valves that close against valve seats on the downstream side of valve seat section 20. Each of the two or more flapper valves include an actuator section to individually control their respective valve. The effect of a plurality of flapper valves is to more finely control the air flow through the modulating check valve to the compressor.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a means) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A modulating check valve adapted for mounting to an inlet of a compressor, comprising:
a flow section, through which fluid flows, having an intake portal, an outlet portal connected to the inlet of the compressor;
a flapper valve disposed in the flow section to prevent backflow from the outlet portal to the intake portal; and
an actuator that controls the flapper valve so that the flapper valve opens, closes and modulates the fluid flow from the intake portal to the outlet portal of the flow section in response to fluid pressure at an outlet of the compressor.

2. The modulating check valve of claim 1 wherein the flow section comprises:
a conduit having the intake portal at one end;
a flapper valve closure section having a valve seat downstream of the intake portal;
an intermediate section disposed downstream from the flapper valve closure section; and
the outlet portal disposed downstream to the intermediate section.

3. The modulating check valve of claim 2 wherein the flapper valve seals against the valve seat.

4. The modulating check valve of claim 1 wherein the compressor is a fluid compressor.

5. The modulating check valve of claim 3 further including a stem disposed within the actuator having a first end extending into the intermediate section of the conduit to movably engage the flapper valve.

6. The modulating check valve of claim 5 wherein:
the flapper valve is a disk-type flapper valve; and
the flapper valve has a closing device to exert a closing force to bias the disk-type flapper valve against the valve seat.

7. The modulating check valve of claim 6 wherein the actuator controls the stem to limit the maximum open angle (W) of the flapper valve while allowing the flapper valve to close and seal against the valve seat without the stem moving.

8. The modulating check valve of claim 7 wherein a second, opposite end of the stem has a spherical end knob to move along a ramp portion of the disk-type flapper valve whereby the flapper valve is moved with respect to the valve seat.

9. The modulating check valve of claim 8 wherein the disk-type flapper valve has an open position of between about 0 degrees and about 85 degrees.

10. The modulating check valve of claim 9 wherein the actuator controls the stem so that the flapper valve modulates open or closed as required by the compressor.

11. A method for modulating the fluid flow to a compressor, comprising:
directing fluid flow through a flow section of a modulating check valve having an intake portal and an outlet portal connected to the inlet of the compressor;
preventing backflow from the outlet portal to the intake portal; and
in response to fluid pressure at an outlet of the compressor, modulating the fluid flow from the intake portal to the outlet portal of the flow section.

12. The method of claim 11 including:
disposing a flapper valve in the flow section; and
modulating the fluid flow from the intake portal to the outlet portal of the flow section with the flapper valve.

13. The method of claim 11 including preventing fluid flow from the intake portal to the outlet portal of the flow section with the flapper valve when the compressor is not operating.

14. The method of claim 13 including opening the flapper valve in response to a rise in the pressure at the outlet of the compressor.

15. The method of claim 14 including opening the flapper valve in response to the fluid being drawn into the compressor.

16. The method of claim 12 including modulating the fluid flow through the modulating check valve by closing the flapper valve as the pressure on the output side of the compressor rises and allowing the flapper valve to open in response to a decrease in the pressure on the output side of the compressor.

17. The method of claim 16 including opening the flapper valve to an open position of between about 0 and about 85 degrees.

18. The method of claim 12 including closing the flapper valve when the rate of fluid flow through the modulating check valve is minimal.

19. The method claim 16 including wherein:
limit the maximum opening of the flapper valve with a stem of an actuator; and
allowing the flapper valve to close without moving the stem.

20. The method claim 11 including directing fluid flow of gas into a fluid compressor.
